(19) United States
(12) Patent Application Publication
(10) Pub. No.: US 2026/0196768 A1
(43) Pub. Date: Jul. 9, 2026

(54) ELECTRICAL CONNECTOR ASSEMBLY WITH FULCRUM MECHANISM

(71) Applicant: Aptiv Technologies AG, Schaffhausen (CH)

(72) Inventors: Nithish SUKUMAR, Tamil Nadu (IN); Norbert DOBERNIG, Lauf (DE)

(21) Appl. No.: 19/442,081

(22) Filed: Jan. 7, 2026

(30) Foreign Application Priority Data
Jan. 9, 2025 (EP) 25150885.9

(51) Int. Cl. H01R 13/627; H01R 13/504; H01R 13/506

(52) U.S. Cl. CPC H01R 13/6272; H01R 13/504; H01R 13/506

(57) ABSTRACT

A connector assembly includes a connector housing configured to receive a terminal and a cover with at least one fastening means for securing the cover to the connector housing. The cover features pivoting means that allow the cover to pivot around a pivoting axis during mounting on the connector housing, allowing for convenient and secure attachment of the cover to the housing.

### CROSS-REFERENCE TO RELATED APPLICATION

This application claims the benefit of and priority to European Application No. 25150885.9 filed with the European Patent Office on January 9, 2025, the contents of which are incorporated by reference herein.

### TECHNICAL FIELD

The present disclosure generally relates to an electrical connector assembly in which a cover is mounted on a connector housing. Such a connector arrangement is in particular useful, but not limited to, in connection with car safety systems for automotive applications, for example, for connecting airbag systems.

### BACKGROUND

In many fields of applications, it is important that a safe coupling between connectors and corresponding counter connectors can be guaranteed. In particular in the case of automotive safety restraint systems, for example airbag systems in passenger vehicles, plug connectors used for the connection of an airbag to its ignition base, i.e. to a squib socket, have to be provided with reliable safety systems. This not only relates to the material and function of the electrical connectors but also to the assembly of the different electrical connector components, which has to be as “fool proof” as possible.

Right-angled terminal systems are frequently housed in connector assemblies to reduce the required space of the assembly. Furthermore, it is necessary that these connector assemblies make sure that the terminal system housed therein is properly located otherwise there is a high safety risk that the terminal system may not be coupled correctly.

In the prior art, connector assemblies for right-angled terminal systems including a connector housing and a cover are known. After the terminal system is inserted into the connector housing, the cover biases the terminal system into the correct position when the cover is mounted onto the connector housing. It has shown however, that the snap connection of covers that are mounted in a translatory movement in the same direction in which the terminal system is inserted into the connector housing, is not always properly engaged. The correct positioning of the terminal system cannot be guaranteed with such a cover and/or the cover may become loose.

To mitigate the problems of correct positioning of the terminal system within the connector housing, another type of cover has been proposed in the prior art. According to this solution, the cover is not mounted by snap connection with the same translatory movement in the direction of insertion of the terminal system but is slid onto the connector housing in a direction perpendicular to the direction of insertion of the terminal system, respectively perpendicular to the mating direction. Although this improves positioning of the terminal system within the connector housing, this solution is not suitable for all types of terminal systems. In particular, terminal systems that do not have a flat rear cannot be used because the sliding cover fails to securely position the terminal system within the connector housing.

To reduce the risks associated with incorrectly coupled or mated connectors in the art so-called connector position assurance (CPA) members were developed. Typically, to this end the connectors are provided with connector position assurance (CPA) members which can be inserted into a locked position on the connector only if the connector is appropriately connected to the corresponding counter connector. In this position, the CPA member provides additional security for the mated state of connector and counter connector, and typically the CPA member is constructed such that an operator can visibly detect if the CPA member is inserted correctly into its locked position. Thus, thereby a correct and safe mating between the connector and the counter connector can be guaranteed.

### SUMMARY

It is an object of the present disclosure to improve the state of the art by providing a connector assembly with an improved cover mounting mechanism. It is in particular the object of the present disclosure to provide a connector assembly which facilitates its assembly, and the positioning of the terminal housed in the connector housing. It is an even further object of the present disclosure to accomplish these tasks by providing an inexpensive connector assembly, which may be produced by injection molding.

Particularly, the above-mentioned object is realized by a connector assembly including a connector housing configured to receive a terminal and a cover with at least one fastening means to retain the cover on the connector housing. The terminal is preferably a right-angled terminal, such as an H-MTD terminal. The cover includes pivoting means designed to lead the cover around a pivoting axis when mounting the cover on the connector housing. In contrast to the covers of the prior art, the cover of the assembly is mounted in a pivoting movement. This has e.g., the advantage that the cover may be used as a lever to force the terminal into its position, where the terminal is received.

When the pivoting means is arranged on an edge of the cover and the at least one fastening means is arranged on the opposite side of the cover (like e.g., in the opposite half of the cover seen), the leveraged force required to mount the cover on the connector housing and to engage the corresponding fastening means is reduced.

In a preferred aspect, the cover is a separate element, that is mountable to the connector housing. This means that the cover is not integral with the connector housing but needs to be mounted thereon. This facilitates the insertion/mounting of the terminal into the connector housing, as the cover may only be afterwards attached to the connector housing.

Advantageously, the pivoting axis lies outside of the cover. In detail, this means that the pivoting axis does not cross the cover or touch the cover, the consequence of this feature being that the cover is not only subjected to a pivoting movement but the cover as a whole is also subjected to a translatory movement when pivoted onto the housing.

To allow a guided pivoting, the connector housing may include a fulcrum support cooperating with the pivoting means upon assembly of cover and connector housing. The fulcrum support is a support about which the cover pivots. Depending on the shape of fulcrum support and pivoting means and further depending on the position of the pivoting means of the cover with respect to the fulcrum support, the pivoting axis can shift its location.

A possible example shape for the fulcrum support is a cylinder section, preferably a 90° cylinder section. While a cylinder section already has a sturdy shape, with a 90° cylinder section, the volume of the cylinder section can be maximized while keeping a section, which is sufficiently large to allow stable pivoting of the pivoting means. In this context, the 90° is not meant as a precise numeric, but deviations of up to +/- 5° are included. The pivoting means cooperating with the cylinder section include a pivot surface that is complementary in shape to the shape of the cylinder section in the mounted position of the cover on the connector housing. Such relatively simple shapes allow a precise molding. The cylinder section can be as wide as one third of the height of a box-shaped portion of the connector housing, to which the cover is to be attached.

When the cylinder section is a circular cylinder section, and the pivot surface is shaped as a circular cutout, the pivoting axis is fixed, i.e. it does not shift with the pivoting of the cover with respect to the connector housing.

The connector housing may include a seat to accommodate the cover in the mounted position, so that the cover is essentially flush with the outer walls of the connector housing. In consequence, the exterior of the connector assembly does not have any protruding parts on which adjacent elements can get caught during installation. Such seat corresponds to a recess in the housing essentially having the shape of the cover. When the connector housing includes such a seat, the fulcrum support can advantageously be made integral with the outer walls of the connector housing and flush with the cover. Though this manufacturing technique requires a higher amount of material at the fulcrum support, it also renders the whole region of the fulcrum support more rigid. Having the fulcrum support integral with the outer walls of the connector housing can further provide manufacturing advantages, as the fulcrum support is created simultaneously with the rest of the connector housing.

In such a constellation, the fulcrum support may protrude into the recessed space such that the fulcrum support is able to prevent a linear movement of the cover against the mating direction of a terminal housed in the connector assembly, when the cover is mounted to the connector housing.

The connector housing may include a linear blocking portion designed to cooperate with a complementary shaped locking portion of the cover opposite the pivoting means. The linear blocking portion guides the cover into the mounted position and retains the cover in the mounted position on the connector housing by blocking a linear movement of the cover perpendicular to the mating direction of the terminal. The movement of the cover in the mating direction is restrained at least by the fastening means. In a preferred embodiment, the cover is further restrained in the mating direction by the fulcrum support. Similarly to the protruding fulcrum support, which has the same height of the outer walls of the connector housing and is flush with the cover when mounted into the seat in the connector housing, the linear blocking means can be of the same height as the outer walls. It can also be integral with the remaining connector housing, for example manufactured simultaneously in a molding process.

Advantageously, the connector assembly is at least partly symmetrical with respect to a symmetry plane, which is perpendicular to the pivoting axis. This may include that the fastening means are symmetrically arranged on opposite sides of the symmetry plane. Additionally, or in replacement, it may also include that the pivoting means are symmetrically arranged on opposite sides of the symmetry plane. In a preferred embodiment, the connector assembly includes exactly two fastening means. This allows a good retention of the cover in the mounted position on the cover with minimal weakening of the cover. It further has the advantage that the loads are equally distributed on either side of the connector assembly. Similarly, the connector assembly may have exactly two pivoting means, which are symmetrically arranged. This is also advantageous for the load distribution, improves the pivoting movement as it gives better lead while pivoting, and can prevent tilting of the cover with respect to the connector housing.

In a preferred embodiment the cover has an essentially U-shaped cross section. The at least one pivoting means is arranged on the base of the U-shaped cover and at least one fastening means is arranged on each leg of the U-shaped cover. This allows to increase the distance between the pivoting means and the fastening means, which in turn lowers the leverage force on the fastening means when the cover is mounted onto the connector housing. When exactly one fastening means is arranged on each leg, a good balance between reliable fastening of the cover on the connector housing and minimal weakening of the cover can be obtained. In case the connector assembly is symmetrical, the legs are parallel to the symmetry plane. In this particular case, the legs are arranged on opposite sides of the symmetry plane.

When the pivot surfaces are arranged on two opposite corners of the U-shaped cover and are embodied by surfaces recessed in part on the legs and in part on the base of the U-shaped cover, and when the fastening means are arranged on opposite legs mainly near the end of the cover opposite the pivot surfaces the distance between the pivoting means and the fastening means is maximized and the required force applied on the fastening means is minimized.

In some embodiments, the fastening means can provide a snap-fit connection of the cover with the housing. The fastening means of the cover can include a snap-fit member and the connector housing can include a corresponding counter member. Alternatively, it is possible that only the cover has a snap-fit member, for example in the shape of a hook, snapping over an edge of the connector housing.

In a preferred embodiment, the snap-fit member includes a snap-fit seat and the counter member includes a snap-fit protrusion. A snap-fit seat and a snap-fit protrusion are both strong connection means that are not prone to breakage, that can be designed to withstand high pullout forces (depending on size and material chosen) and that are easily manufactured.

To adapt the protrusion to the pivoting movement, the snap-fit protrusion can have a general box-like shape and include two ramps arranged at an angle relative to each other and two abutments arranged at an angle relative to each other. This way the cover is not blocked by the snap-fit protrusion when it is pivoted onto the connector housing. Instead, the cover is pushed onto and deflected by the ramps. With the pivoting movement of the cover, the snap-fit seat is pivoted on top of the snap-fit protrusion of the connector housing where the snap-fit protrusion engages the snap-fit seat. In the mounted position, when the snap-fit protrusion is in engagement with the snap-fit seat, the abutments each abut an interior surface of the snap-fit seat. The abutments prevent a linear movement of the cover against the mating direction.

### BRIEF DESCRIPTION OF THE DRAWINGS

In the following, preferred embodiments of the disclosure are described by reference to the accompanying figures, in which:

FIGS. 1a to 1c show the mounting sequence of a connector assembly according to an embodiment of the prior art.

FIGS. 2a and 2b show an embodiment of a connector assembly prior to mounting the cover on the connector housing according to some embodiments.

FIGS. 3a to 3d show the mounting sequence of the connector assembly of FIGS. 2a and 2b according to some embodiments.

FIGS. 4a to 4c show the mounting sequence of a detail of the pivoting means and the fulcrum support of the connector assembly according to some embodiments.

FIG. 5 shows a detail of the fastening means in the mounted position of the cover on the connector housing according to some embodiments.

### DETAILED DESCRIPTION

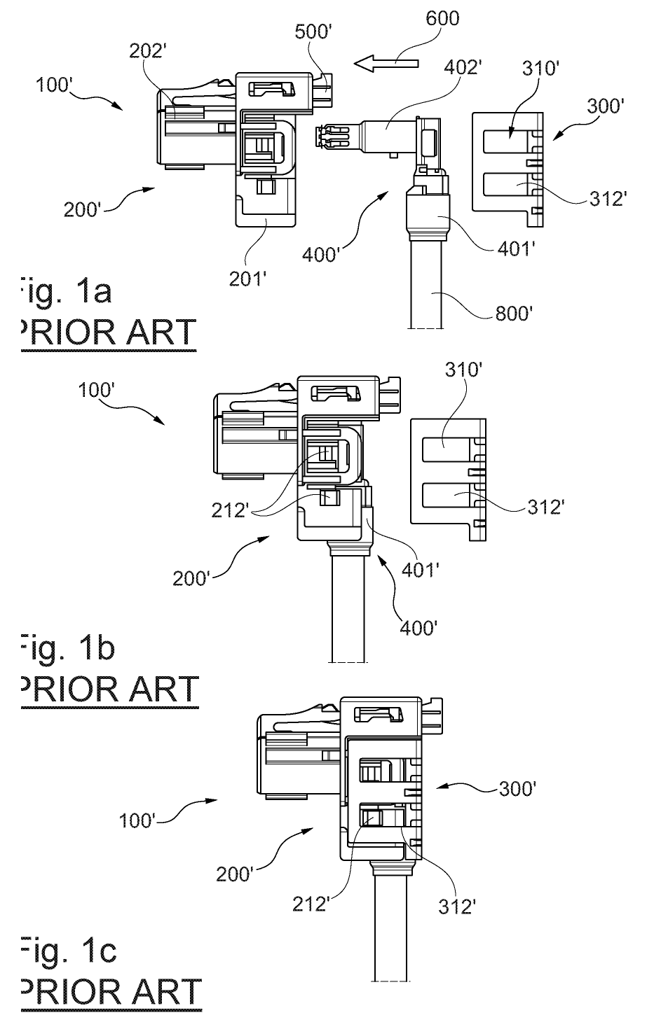

FIGS. 1a-1c show a connector assembly 100’ according to the prior art. The connector assembly 100’ includes a connector housing 200’ and a cover 300’. The connector housing 200’ has a box-shaped portion 201’ and a plug portion 202’ to accommodate an essentially L-shaped right-angled terminal 400’. The terminal 400’ has a body 401’ connected to a cable 800’ and a plug 402’. The mating direction 600 of the terminal 400’ is defined as the direction in which the plug portion 202’ is plugged into a corresponding socket (not shown). To ensure a correct positioning of all elements within the connector assembly 100’, the connector housing 200’ includes a connector position assurance (CPA) device 500’ that is a secondary locking device that can be activated if predetermined elements of the connector assembly 100’ are correctly mounted. The functioning of such a CPA device 500’ is generally known.

In FIG. 1b the terminal 400’ has been inserted into the connector housing 200’ following the mating direction 600. The terminal 400’ is secured within the box-shaped portion 201’ of the connector housing 200’ by means of the cover 300’. To this end, the cover 300’ includes fastening means 310’ retaining the cover 300’ on the box-shaped portion 201’ of the connector housing 200’. In the shown connector assembly 100’, each side of the cover 300’ has two snap-fit seats 312’ cooperating with snap-fit protrusions 212’ provided on the connector housing 200’. The cover 300’ is also mounted on the connector housing 200’ following the mating direction 600.

In FIG. 1c the connector assembly 100’ is shown in fully mounted condition. To reliably keep the terminal 400’ in place, the snap-fit seats 312’ of the cover 300’ need to firmly engage with the snap-fit protrusions 212’ on the connector housing 200’ to push the terminal 400’ into the connector housing 200’ and hold it within. When insufficient force is applied, the snap-fit seats 312’ may not entirely engage with the snap-fit protrusions 212’, which can lead to the cover 300’ falling off from the connector housing 200’. The disclosure seeks to remedy this, and other problems known from the prior art.

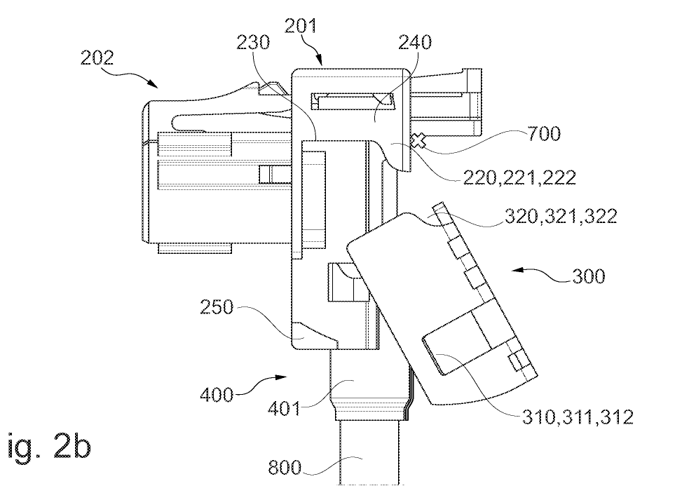

FIG. 2a and 2b show an embodiment of a connector assembly 100 prior to mounting the cover 300 on the connector housing 200 from a slightly tilted 3-D perspective in FIG. 2a and in a side view in FIG. 2b . In the following, the same reference numbers are used in the description of the invention as in the description of the prior art for the same or similar components, differentiated by an apostrophe. Therefore, in some instances it is refrained from describing the same components again, to avoid repetitions.

The connector housing 200 is similar to the connector housing 200’ of the prior art in that it includes a box-shaped portion 201, designed to at least partially receive the body 401 of terminal 400, and a plug portion 202, designed to receive the plug 402 of the terminal 400 (not visible FIG. 2a or 2b). In the shown embodiment, the connector housing 200 includes a fulcrum support 220 designed to cooperate with pivoting means 320 of the cover 300 upon assembly of connector housing 200 and cover 300. The fulcrum support 220 is shaped as a cylinder section 221, in particular as a circular cylinder section 222. In the shown embodiment, the support includes two symmetrical cylinder sections 222. As in this particular embodiment the fulcrum support 220 is a circular cylinder section 222, it defines a fixed pivoting axis 700. This pivoting axis 700, around which the cover 300 pivots when mounted onto the connector housing 200, lies outside of the cover 300, i.e. the pivoting axis 700 does not cross or touch the cover 300. The connector housing 200 further includes a seat 230 on its box-shaped portion 201 to accommodate the cover 300 in the mounted position, so that the cover 300 is essentially flush with outer walls 240 of the connector housing 200. On one side, the contour of the seat 230 is defined by an abutment edge 231 and the fulcrum support 220. On the other side, the contour of the seat 230 is defined by a linear blocking portion 250 designed to cooperate with a complementary shaped locking portion 350 of the cover 300, to block a linear movement of the cover 300. Within the surface of the seat 230, the connector housing 200 has two snap-fit protrusions 212 on opposite sides (only one visible in FIG. 1a due to the perspective), which is a counter member 211 to a snap-fit member 311 of the cover 300. The shape of the snap-fit protrusion 212 will be explained in further detail when describing FIG. 5.

The skilled person may understand from the various views of the inventive embodiment, that the connector assembly shown is symmetrical with respect to a symmetry plane, which is perpendicular to the pivoting axis 700, and arranged between the legs 332 of the cover 300.

In the 3D-view of FIG. 2a the shape of the cover 300 is readily apparent: the cover 300 has a general U-shaped cross-section 330 with a base 331 and two legs 332. The legs 332 extend symmetrically on each side of the base 331. In the shown embodiment, the pivoting means 320 are arranged on an edge of the cover 300, substantially on the base 331 of the cover 300, while a fastening means 310 is symmetrically arranged on each leg 332 on the side of the cover 300 opposite the pivoting means 320 (i.e., in the half of the cover 300 opposite the pivoting means 320).

In the unmounted state, the cover 300 is separate from the connector housing 200, i.e., it is a distinct element, not integral with the housing. To mount the cover 300 on the connector housing 200, the pivoting means 320 lead the cover 300 around the pivoting axis 700 defined by the fulcrum support 220. The pivoting means 320 include a pivot surface 321, which is complementary to the shape of the cylinder section 221 of the fulcrum support 220. The pivoting means 320 are realized in form of two symmetrical pivot surfaces corresponding to the two symmetrical cylinder sections 221. In particular, the shown pivoting means 320 are circular cutouts 322 arranged on opposite corners of the U-shaped cover 300 and recessed in part on the base 331 of the cover 300 and in part on the legs 332. The fastening means 310 of the shown cover 300 are arranged on opposite legs 332 mainly opposite the pivot surfaces 321 and provide a snap-fit connection with the connector housing 200. The fastening means 310 are shaped as snap-fit members 311, more specifically as snap-fit seats 312 cooperating with the snap-fit protrusions 212.

The position of the axis 700 becomes clearer in the plane shown in FIG. 2b, this plane being perpendicular to the axis 700. In this embodiment, the shape of the circular cylinder section 222 defines an axis 700, which is slightly shifted outside of the box-shaped portion 201 of the connector housing 200, as visualized by the cross representing the axis 700.

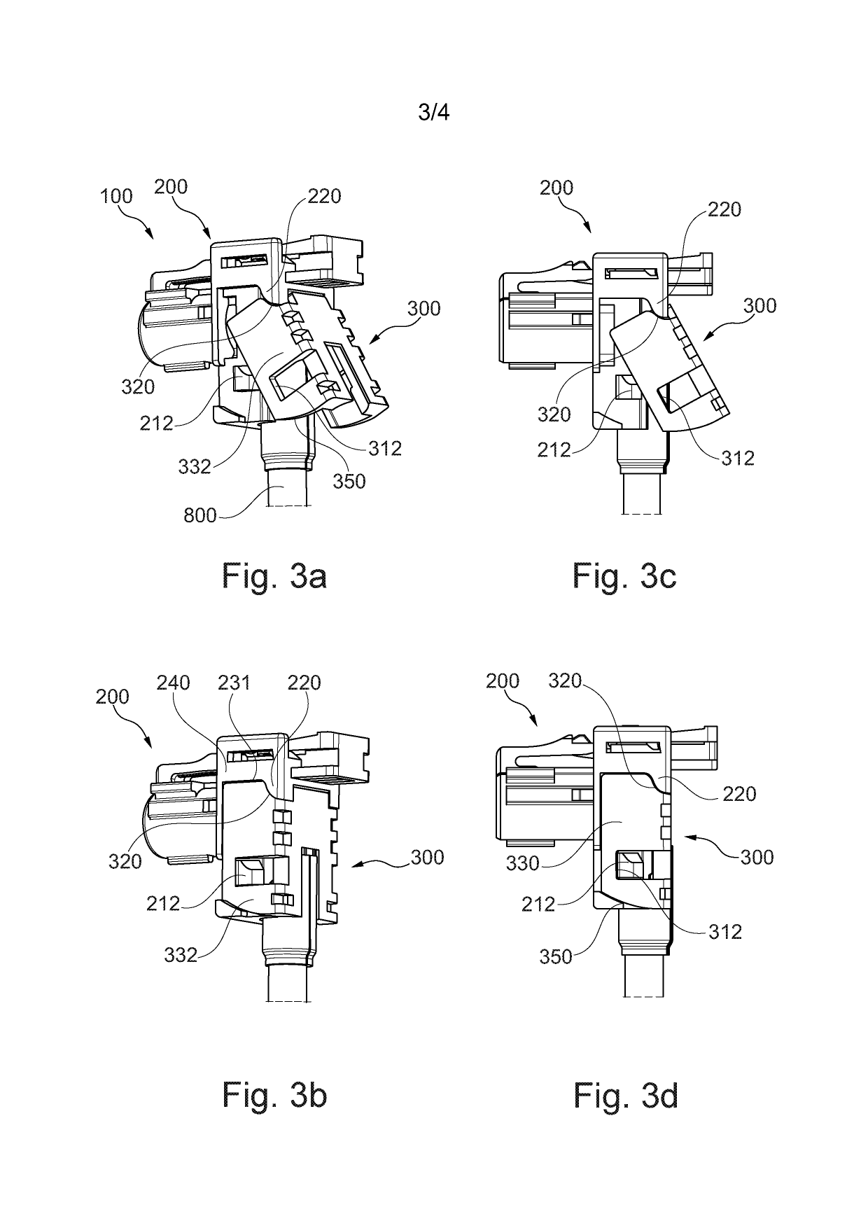

FIGS. 3a to 3d show the mounting steps of the cover 300 on the connector housing 200. While FIG. 3a and 2b show the connector assembly 100 in a 3D-perspective, the FIG. 3c and 3d show the same steps of FIG. 3a and 3b respectively in a plane or side view.

In the first mounting step shown in FIG. 3a and 3c, the pivoting means 320 of the cover 300 engage the housing 200 at the fulcrum support 220 in a tilted position of the cover 300. The fulcrum support 220 guides the cover 300 in a pivoting movement to the mounted position. Before reaching the mounted position, the legs 332 of the cover 300 need to overcome the snap-fit protrusion 212 on the connector housing 200. Typically, the cover 300 is made of resilient material that may allow the legs 332 to elastically bend to overcome the snap-fit protrusion 212.

FIG. 3b and 3d depict the mounted position of the cover 300 on the connector housing 200 when the cover 300 is pivoted further on the fulcrum support 220. After bending outward to overcome the snap-fit protrusion 212, the legs 332 may resiliently snap back into their original position, as soon as the position of the snap-fit protrusion 212 matches the position of the snap-fit seat 312, thereby fastening the cover 300 on the connector housing 200. In the mounted position, the cover 300 is received within the seat 230 such that the cover 300 is flush with the outer wall 240 of the connector housing 200. The locking portion 350 of the cover 300 is located at the end of the cover 300 opposite the pivoting means 320. The locking portion 350, complementary in shape to the linear blocking portion 250 of the connector housing 200, guides the cover 300 into the mounted position. Additionally, because of its curved shape, the linear blocking portion 250 and the locking portion 350 push the cover 300 towards the abutment edge 231 and into a recess formed by the abutment edge 231 and the fulcrum support 220. When the cover 300 is fastened by the snap-fit seat 312 and the snap-fit protrusion 212, it is held against the mating direction 600 by the fulcrum support 220 and the snap-fit connection, and perpendicular to the mating direction within the seat 230 by the abutment edge 231 and the linear blocking portion 250.

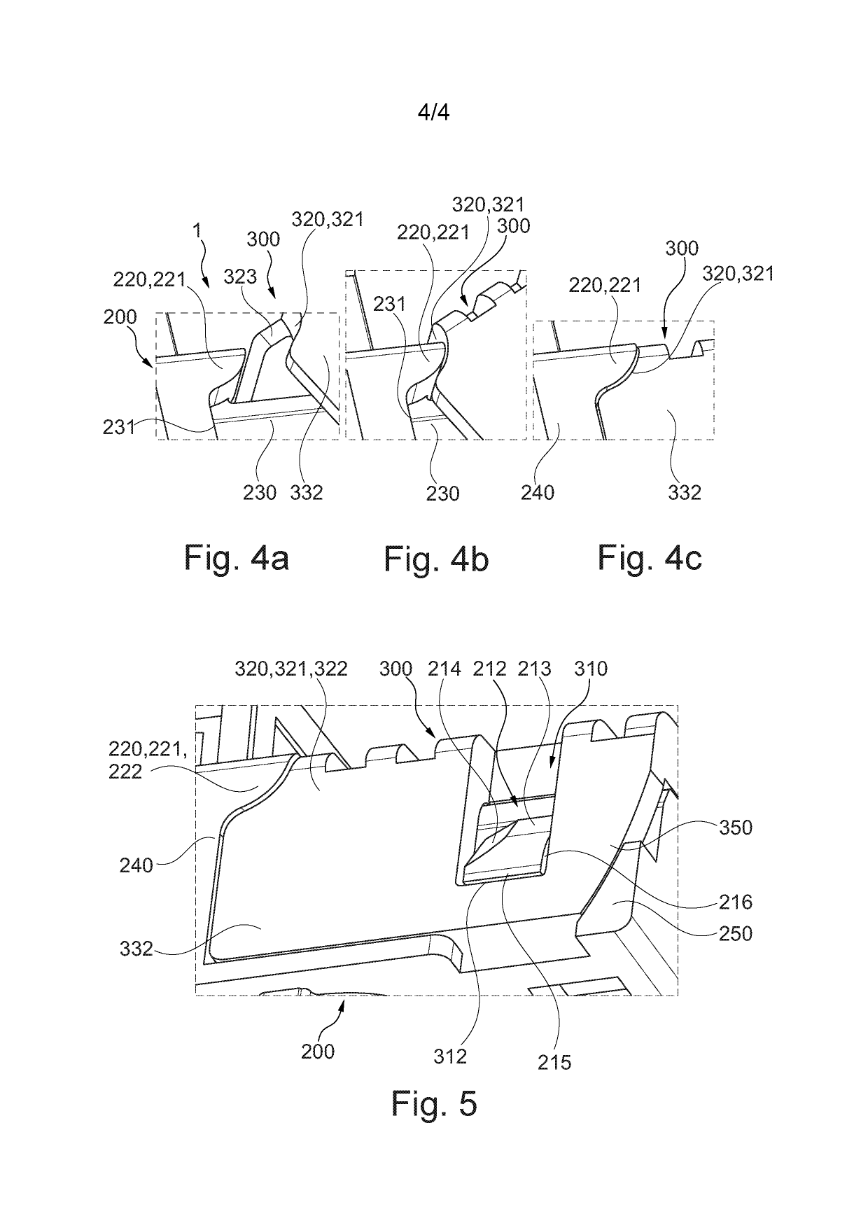

FIG. 4a, b and c show the mounting sequence of a detail of the pivoting means 320 and the fulcrum support 220 of connector assembly 100. In FIG. 4a, the cover 300 does not yet touch the connector housing 200 (this position corresponds to the position of FIGS. 2a, 2b). The pivot surface 321 is formed by the circular cutout 322 that is partly made in the base 331 of the cover 300 and partly in the legs 332. The width of the pivot surface 321 substantially corresponds to the thickness of the legs 332 of the cover 300. On the connector housing 200, the width of the cylinder section 221 is equivalent to the depth of the seat 230. In the example shown, the width of the pivot surface 321 is substantially equivalent to the width of the cylinder section 221. This has the advantage that flush outer walls 240 and cover 300 can reliably be obtained, as shown in FIG. 4c, while maximizing the pivoting area, as shown in FIG. 4b, for a sturdy and reliable connection.

FIG. 5 shows a detail of the fastening means 310 in the mounted position of the cover 300 on the connector housing 200. The snap-fit protrusion 212 has a general box-like shape and includes two ramps, an upper ramp 213 and a side ramp 214, arranged at an angle relative to each other and two abutments, a lower abutment 215 and a side abutment 216 arranged at an angle relative to each other. The upper ramp 213 and the side ramp 214 together allow bending the legs 332 of the cover 300 outwards when the cover 300 is pivoted. The lower abutment 215 and side abutment 216 hold against the inner walls of the snap-fit seat 312 when the snap-fit protrusion 212 is engaged within the snap-fit seat 312 and prevent vertical movement of the cover 300 opposite the mating direction 600 and lateral movement perpendicular to the mating direction 600. The provision of two ramps arranged at an angle to each other facilitate advantageously the mounting of the cover 300, as the orientation of the ramps is adjusted to the pivoting movement of the cover 300 during the mounting process.

While the invention has been described with reference to an exemplary embodiment(s), it may be understood by those skilled in the art that various changes may be made, and equivalents may be substituted for elements thereof without departing from the scope of the invention. In addition, many modifications may be made to configure a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It may also be understood that, although the terms first, second, etc., are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It may also be understood that the term “and/or” as used herein refers to and encompasses any and all possible combinations of one or more of the associated listed items. It may be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

1. A connector assembly, comprising:
a connector housing configured to receive a terminal, and
a cover with at least one fastening means to retain the cover on the connector housing, wherein the cover comprises pivoting means designed to lead the cover around a pivoting axis when mounting the cover on the connector housing.

2. The connector assembly according to claim 1, wherein the pivoting means is arranged on an edge of the cover and the at least one fastening means is arranged on an opposite side of the cover.

3. The connector assembly according to claim 1, wherein the cover is a separate element, that is mountable to the connector housing.

4. The connector assembly according to claim 1, wherein the pivoting axis lies outside of the cover.

5. The connector assembly according to claim 1, wherein the connector housing comprises a fulcrum support cooperating with the pivoting means upon assembly of cover and connector housing.

6. Connector assembly according to claim 5, wherein the fulcrum support is shaped as a cylinder section, and the pivoting means comprise a pivot surface that is complementary in shape to the shape of the cylinder section in a mounted position of the cover on the connector housing.

7. Connector assembly according to claim 6, wherein the cylinder section is a 90° cylinder section, and the pivoting means comprise a pivot surface that is complementary in shape.

8. Connector assembly according to claim 7, wherein the cylinder section is a circular cylinder section, and the pivot surface is shaped as a circular cutout.

9. The connector assembly according to claim 6, wherein the cover has an essentially U-shaped cross section, wherein the pivoting means is arranged on a base of the U-shaped cover, and a fastening means is arranged on each leg of the U-shaped cover, wherein exactly one fastening means is arranged on each leg.

10. Connector assembly according to claim 9, wherein the pivot surfaces are arranged on two opposite corners of the U-shaped cover and are embodied by surfaces recessed in part on the legs and in part on the base of the U-shaped cover and wherein the fastening means are arranged on opposite legs mainly near an end of the cover opposite the pivot surfaces.

11. The connector assembly according to claim 9, wherein the cover has an essentially U-shaped cross section, wherein the pivoting means is arranged on the base of the U-shaped cover, and a fastening means is arranged on each leg of the U-shaped cover, wherein the legs are parallel to a symmetry plane, the legs being arranged on opposite sides of the symmetry plane.

12. The connector assembly according to claim 6, wherein the connector housing comprises a seat to accommodate the cover in the mounted position, so that the cover is essentially flush with outer walls of the connector housing.

13. The connector assembly according to claim 6, wherein the connector housing includes a linear blocking portion designed to cooperate with a complementary shaped locking portion of the cover opposite the pivoting means to retain the cover in the mounted position on the connector housing blocking a linear movement of the cover perpendicular to a mating direction of the terminal.

14. The connector assembly according to claim 1, wherein the connector assembly is symmetrical with respect to a symmetry plane, the symmetry plane being perpendicular to the pivoting axis, and wherein the fastening means and/or the pivoting means are symmetrically arranged on opposite sides of the symmetry plane.

15. The connector assembly according to claim 14, wherein the connector assembly comprises exactly two fastening means.

16. The connector assembly according to claim 14, wherein the connector assembly comprises exactly two pivoting means.

17. The connector assembly according to claim 1, wherein the fastening means provide a snap-fit connection with the housing, the fastening means of the cover comprising a snap-fit member and the connector housing comprising a corresponding counter member.

18. The connector assembly according to claim 17, wherein the snap-fit member comprises a snap-fit seat and the counter member comprises a snap-fit protrusion.

19. The connector assembly according to claim 18, wherein the snap-fit protrusion has a general box-like shape and includes two ramps arranged at an angle relative to each other and two abutments arranged at an angle relative to each other, wherein the ramps are positioned such that the snap-fit protrusion engages the snap-fit seat during mounting and wherein the abutments are designed such that each abuts an interior surface of the snap-fit seat in the mounted position of the cover.
